(19) United States
(12) Patent Application Publication
(10) Pub. No.: US 2014/0245447 A1
(43) Pub. Date: Aug. 28, 2014

(54) METHOD, DEVICE AND SYSTEM FOR TROJAN HORSE INTERCEPTION

(71) Applicant: Tencent Technology (Shenzhen) Company Limited, Shenzhen City (CN)

(72) Inventors: Wen Tan, Shenzhen City (CN); Rongjun Li, Shenzhen City (CN)

(73) Assignee: Tencent Technology (Shenzhen) Company Limited, Shenzhen City (CN)

(21) Appl. No.: 14/269,654

(22) Filed: May 5, 2014

Related U.S. Application Data
(63) Continuation of application No. PCT/CN2013/088567, filed on Dec. 5, 2013.

(30) Foreign Application Priority Data
Jan. 15, 2013 (CN) 201310013857.2

(51) Int. Cl. G06F 21/56

(52) U.S. Cl. CPC G06F 21/561
USPC 726/24

(57) ABSTRACT

A method, a device and a system for Trojan horse interception are provided. The method includes: intercepting input information from a user, and determining whether the input information is identical to saved information to be protected; and sending a warning prompt, when the input information is identical to the saved information to be protected and it is determined that an input target object of the input information is not a legitimate object. According to the above scheme, all the input information can be intercepted, and a warning is sent if the input information is identical to the saved information to be protected and the input target object of the input information is not legitimate; the above scheme is not limited to monitor a certain input target object, and thus has increased applicability.

### RELATED APPLICATIONS

This application is a continuation application of International Application No. PCT/CN2013/088567, titled “METHOD, DEVICE AND SYSTEM FOR TROJAN HORSE INTERCEPTION”, filed on Dec. 5, 2013, which claims priority to Chinese patent application No. 201310013857.2 titled “Method, device and system for trojan horse interception” and filed with the State Intellectual Property Office on Jan. 15, 2013, which is incorporated herein by reference in its entirety.

### FIELD

The present disclosure relates to the technical field of communication, and in particular to a method, device and system for trojan horse interception.

### BACKGROUND

In order to prevent usernames and passwords of online banking accounts, online gaming accounts, and other network accounts from being stolen, extensive research has been made by technical staff, and various schemes have been used to prevent usernames and passwords from being stolen.

A special account and/or password input control is used to prevent an input from being intercepted.

### SUMMARY

In embodiments of the present disclosure, a method, device and system for trojan horse interception is provided, which is adapted to provide a scheme which has extensive applicability and lower user requirements so as to enhance security.

One method for trojan horse interception may include intercepting input information, and determining whether the input information is identical to, e.g., the same as, saved information to be protected; and sending a warning prompt, if the input information is identical to the saved information to be protected and it is determined that an input target object of the input information is not a legitimate object.

A device for trojan horse interception may include an input unit adapted to receive input information; an intercepting unit adapted to intercept the input information inputted by a user through the input unit; a comparison unit adapted to determine whether the input information intercepted by the intercepting unit is identical to the saved information to be protected; a legitimacy determination unit adapted to determine whether an input target object of the input information is a legitimate object when the comparison unit determines that the input information is identical to the saved information to be protected; and a warning unit adapted to send a warning prompt when the legitimacy determination unit determines that the input target object of the input information is not a legitimate object.

A system for trojan interception may include a terminal and a cloud server. The terminal may be adapted to intercept input information from a user and determine whether the input information is identical to (e.g., the same as) saved information to be protected; and send a warning prompt, when the input information is identical to the saved information to be protected and a query by the terminal to the cloud server shows that an input target object of the input information is not a legitimate object.

It can be seen from the above technical scheme that embodiments of the present disclosure may have the following advantages: according to the above scheme, all the input information can be intercepted, and a warning is sent if the input information is the same as the saved information to be protected and an input target object of the input information is not legitimate; the above scheme is not limited to monitoring a certain input target object, thereby making the application range more extensive; and it is unnecessary for the user to enter the correct web address or operate the correct program, so the requirement for the user is lowered, and thereby the above scheme has better security.

### BRIEF DESCRIPTION OF THE DRAWINGS

In order to illustrate the technical solutions of the embodiments of the present disclosure more clearly, drawings to be used in the description of the embodiments will be described briefly hereinafter. The drawings described hereinafter are only some embodiments of the present disclosure, and other drawings may be obtained by those skilled in the art according to these drawings without creative labor.

FIG. 1 is a schematic flow chart of a method according to an embodiment of the present disclosure;

FIG. 2 is a schematic flow chart of another method according to an embodiment of the present disclosure;

FIG. 3 is a schematic diagram of a data flow according to an embodiment of the present disclosure;

FIG. 4 is a schematic structural diagram of a device according to an embodiment of the present disclosure;

FIG. 5 is a schematic structural diagram of another device according to an embodiment of the present disclosure;

FIG. 6 is a schematic structural diagram of still another device according to an embodiment of the present disclosure; and

FIG. 7 is a schematic structural diagram of a system according to an embodiment of the present disclosure.

### DETAILED DESCRIPTION

The technical solutions in the embodiments of the present disclosure will be further described in detail hereinafter in conjunction with the drawings, so that the objects, technical solutions and advantages of the present disclosure will be clear. The described embodiments are only a part but not all of the embodiments of the present innovation. All the other embodiments can be obtained by those skilled in the art without creative effort on the basis of the embodiments of the present disclosure, which fall within the scope of protection of the present disclosure.

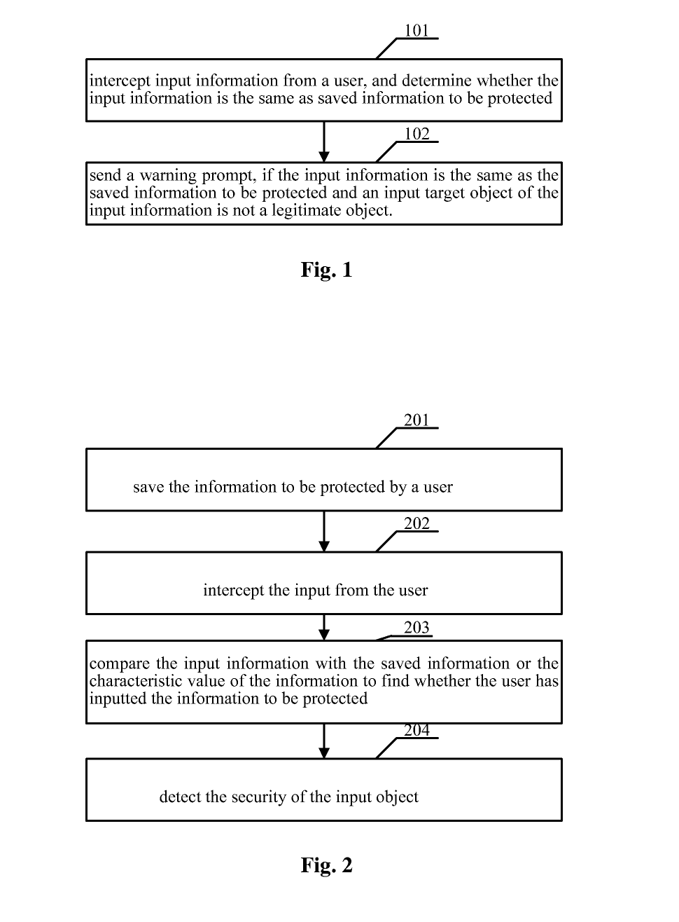

According to an embodiment of the present invention, a method for trojan interception is provided as shown in FIG. 1, which includes step 101 and step 102.

101: Intercepting input information from a user, and determining whether the input information is the same as saved information to be protected.

The information may be an important account and password, and may also be other information to be protected. The specific form of the information does not limit the embodiment of the present disclosure.

Preferably, in order to further improve security, it is possible that the non-reversible representation of the saved information and derived from the saved information is saved on the terminal side, e.g., instead of the information itself. In particular, before the determining whether the input information is identical to the saved information to be protected, the method may further include receiving the information to be protected, converting the information to be protected into non-reversible representation of information (e.g., converting the information to be protected into non-reversible data corresponding to the information), and saving the non-reversible representation of the information. The non-reversible representation of the information may refer to any information that cannot be adapted to recover the information by conversion, for example, the common Message Digest Algorithm 5 (MD5) value.

102: Sending a warning prompt, if the input information is the same as the saved information to be protected and an input target object of the input information is not a legitimate object.

The manner of the warning prompt make take various forms, such as presenting a warning prompt dialog box, or sending an audio warning. The specific form of the warning prompt does not limit the embodiment of the present disclosure.

According to the above scheme, some or all of the input information can be intercepted, and a warning is sent if the input information is the same as the saved information to be protected and an input target object of the input information is not illegitimate (e.g., legitimate); the above scheme is not limited to monitoring a certain input target object, and as such, the application range is more extensive. Also, it is unnecessary for the user to enter a correct web address or operate a correct program, so the requirement for the user is lowered, and therefore the above scheme has enhanced security.

Corresponding to the saving the non-reversible representation of the information, e.g., in step 102 described above, determining whether the input information is the same as saved information to be protected may include: converting the input information into the non-reversible representation of the input information and corresponding to the input information, and determining whether the non-reversible representation of the input information corresponding to the input information is identical to the saved non-reversible representation of the information to be protected.

One example of the non-reversible representation information is provided according to an embodiment of the present invention, such that the non-reversible representation of information described above is a hash algorithm value determined from applying a hash algorithm or function to the information. The MD5 value described above may be one of the values obtained by the hash algorithm.

More particularly, one example implemented by using a cloud server is provided according to an embodiment of the present invention. The method for determining whether the input target object of the input information is not a legitimate object may include: comparing characteristic information of the input target object of the input information with legitimate characteristic information of the input target object saved in a cloud server, and determining that the input target object of the input information is not a legitimate object if the characteristic information of the input target object of the input information has illegitimate information or unknown information.

Further, according to an embodiment of the present disclosure, a scheme through which an illegitimate object at cloud end can be counted or identified and the ability of identifying the trojan can be enhanced is provided. In particular, after the determining that the input target object of the input information is not a legitimate object, the method may further include: gathering or obtaining characteristic information of the input target object of the input information, and sending the input target object of the input information to the cloud server as an illegitimate object if it is determined, in accordance with the characteristic information, that the input target object of the input information is or includes a malicious program.

One important idea of the above scheme is, firstly, setting the information to be protected, such as an important account and a password of the user at the local terminal. It is noted that these important accounts does not mean that the passwords of the accounts are actually saved at the local terminal, and it is only required to store a certain identifying characteristic or non-reversible representation (such as MD5 value) of the password. Once the information to be protected is set, these accounts and passwords can be protected by the scheme according to an embodiment of the present disclosure.

After the starting of the terminal, a terminal may intercept an input from a user obtain the input information from the user. The interception can be implemented by a kernel driving program, for example. Through this step, regardless of which window the user inputs the information, the input from the user can be detected through the kernel driving program, including when the user inputs the account and password which are set to be protected.

After detecting that the user has inputted the information to be protected (e.g., the input information is identical to an account name and/or password), a security check is performed by the terminal. The security check may be to verify whether the object window in which the user inputs or the uniform resource locator (URL) of the accessed web page is legitimate. If the object window in which the user inputs or the URL of the accessed web page is confirmed as legitimate, the operation of the user is permitted to proceed. If the object window in which the user inputs or the URL of the accessed web page is determined as illegitimate, a different measure can be adopted, for example, by prompting the user to pay attention to security risks, or gathering enough information and sending the information to backend server to analyze the possibility of a trojan horse and the URL of the illegitimate fishing site manually. Further, if new information of a trojan horse and the URL of a fishing site are found, the new information can be stored in the cloud server to continually improve the accuracy of cloud query.

Because this technology can be performed on all interfaces in user terminals (initial screening of the interfaces should be done before this technology is used), therefore, there could be a high finding probability regardless of whether the security check is performed on a known or in an unknown identification theft interface (including various fishing sites, ID theft trojan horse, or the like).

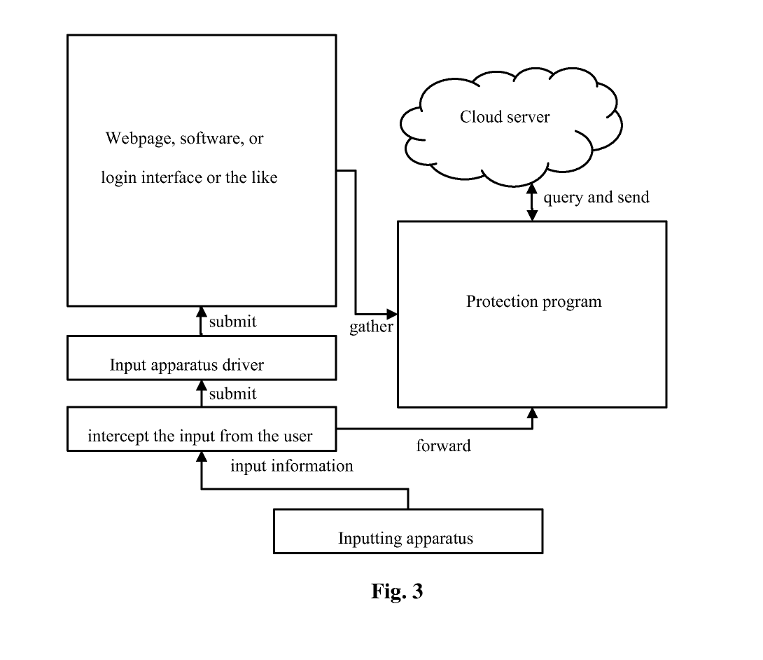

To provide another illustration, the following embodiment is presented as an example of trojan horse interception for instant messaging software with reference to FIG. 2 together with FIG. 3.

201: Saving the information to be protected by a user in a suitable manner.

The information to be protected may be an account of instant message software, an account of various games, an account and its password of online banking, or the like. The scheme for saving the information can be that the user inputs information for these accounts actively and then saves the accounts. Since the account can be used in conjunction with the software through an application, such as instant message software, it is not necessary for the user to input the accounts actively. For example, when the user logins to instant messaging software at a local terminal, the account and password of the instant information software can be automatically set in the protection program which is implemented according to an embodiment of present disclosure.

In addition, information saved and to be protected can be divided into two types: one type is public information (such as, username), and the other type is confidential information (such as, password). Even though the protection program implements security of self-protection, the risk for leakage of the confidential information can be increased if confidential information such as a password is stored in a medium such as a memory or configuration file. Accordingly, the public information can be saved directly unto the terminal and the confidential information can be saved by saving a certain characteristic value (such as, MD5 value) or non-reversible representation of the confidential information. Since the data itself cannot be calculated according to the MD5 value of the data, the risk for leakage of confidential information is avoided.

202: Intercepting the input (including input operation of mouse and keyboard) from the user.

Referring to FIG. 3, the user inputs input information through an input apparatus, the input information inputted by the user is intercepted, the intercepted information is sent to a protection program, and the input information can also be driven by the inputting apparatus to be submitted to an inputting object such as a webpage, software, or login interface along the original path.

There are many alternative implementation schemes to intercept the input from the user, for example:

A: installing a hook in an application layer by using a hook interface provided by Microsoft Windows, wherein the hook can record the information of inputs from a keyboard and mouse; and

B: Developing a Windows kernel driver program applicable to the keyboard and mouse apparatus in the Windows, wherein the message sent by the hardware is firstly sent to this driver program.

203: After intercepting the input information inputted by the user through the keyboard, mouse, or the like, comparing the input information with the saved information or characteristic value of the saved information so as to determine whether the information (account and password) to be protected is inputted by the user.

Because optionally all the input information of the user is monitored in this scheme, the input information from the user corresponding to saved information to be protected can be captured with high probability for each environment which the user is in, for example, accessing webpages, logging into games or other applications, logging in to other types software, or being cheated by an identification theft Trojan horse.

204: Detecting the security of the input object.

Generally speaking, the input object is likely to be software, for example, instant messaging software, game or other software, or a Web with an URL which is being visited by a browser. Legitimacy detection often can be done in conjunction with a backstage or backend cloud query. As shown in FIG. 3, information of software or a visited URL being accessed is gathered by the protection program, and sent to the background cloud server for querying. The cloud server returns a result about whether the information is legitimate. The protection program can also gather or obtain characteristic or other information (such as, the sample of executable file and URL link) of the illegitimate process and send the information to the cloud serve, if the result is illegitimate. These illegitimate samples can be analyzed by a security staff.

According to the above scheme, all the input information can be intercepted, and a warning is sent if the input information is identical to the saved information to be protected and it is determined an input target object of the input information is not illegitimate. The above scheme is not limited to monitoring a certain or particular input target object, as all inputs of a user can be intercepted. Accordingly, the range of applications protected by the scheme is more extensive, and it is unnecessary for the user themselves to take precautions in entering the correct web address or operating the correct program, thus reducing user requirement. Thus, the above scheme may provide better security. It is beneficial to find an illegitimate object when the various possible illegitimate characteristic information is sent to the cloud server, thereby the above scheme provides protection for finding unknown trojan horses as well.

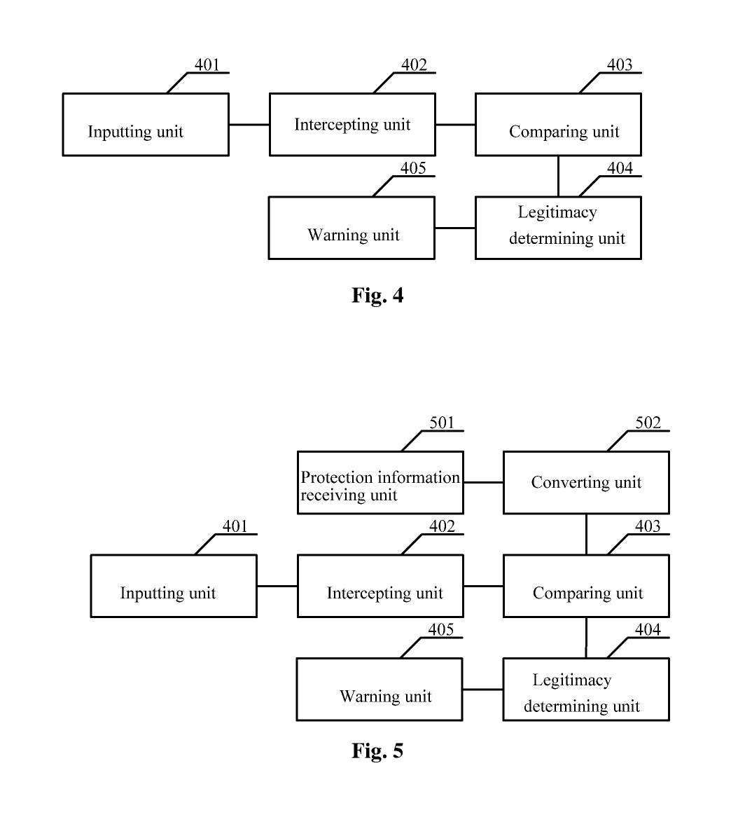

According to an embodiment of the present disclosure, a device for trojan interception is provided, as shown in FIG. 4, which includes:

an inputting unit 401, adapted to receive input information from a user;

an intercepting unit 402, adapted to intercept the input information which is inputted by the user through the inputting unit 401;

a comparing unit 403, adapted to determine whether the input information which is intercepted by the intercepting unit 402 is the same as (e.g., identical to) saved information to be protected;

a legitimacy determining unit 404, adapted to determine whether an input target object of the input information is a legitimate object if it is determined by the comparing unit 403 that the input information which is intercepted by the intercepting unit is identical to the saved information to be protected; and

a warning unit 405, adapted to send a warning prompt when it is determined by the legitimacy determining unit 404 that the input target object of the input information is not a legitimate object.

According to the above scheme, all the input information can be intercepted, and a warning is sent if the input information is identical to the saved information to be protected and an input target object of the input information is not illegitimate. The above scheme is not limited to monitor a certain input target object, and as such, range of applications that are protected is more extensive. It may be unnecessary for the user to take precautions in entering the correct (e.g., non-malicious) web address or operating the correct program, so the requirement for the user is lowered, and thereby the above scheme provides enhanced security.

Further, in order to further improve security, it is possible that a non-reversible representation of confidential information to be protected and derived from the confidential information is saved at the terminal side, instead of the confidential information itself. As shown in FIG. 5, the device further includes:

a protection information receiving unit 501, adapted to receive the information to be protected before it is determined whether the input information is identical to the stored information to be protected; and

a converting unit 502, adapted to convert the information to be protected which is received by the protection information receiving unit 501 into non-reversible representation information to be protected and for saving, and convert the input information which is intercepted by the intercepting unit 501 into the non-reversible representation of the input information corresponding to the input information,

wherein the comparing unit 403 is adapted to determine whether the non-reversible representation of the input information corresponding to the input information is identical to the saved non-reversible representation of the information to be protected.

In some variations, the converting unit 502 is adapted to convert the information to be protected which is received by the protection information receiving unit 501 into a hash algorithm value, and convert the input information which is intercepted by the intercepting unit 402 into a hash algorithm value corresponding to the input information.

In some variations, the comparing unit 403 is adapted to: compare characteristic information of the input target object of the input information with legitimate characteristic information of the input target object saved in a cloud server, and determine that the input target object of input information is not a legitimate object if the characteristic information of the input target object of the input information has illegitimate information or unknown information.

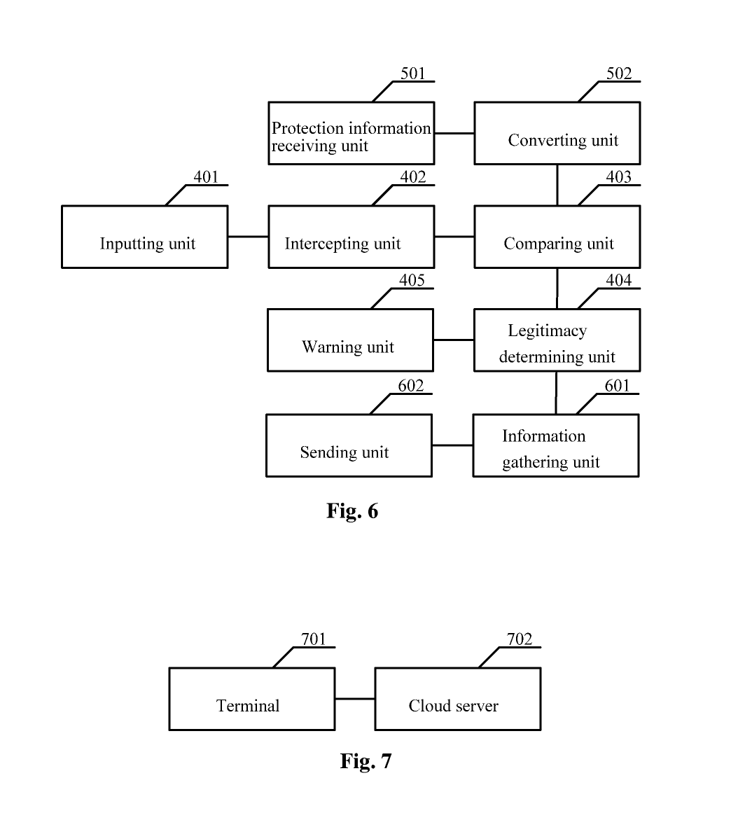

Further, a scheme which is implemented using the cloud server is provided according to an embodiment of the present disclosure, as shown in FIG. 6, and the device further includes:

an information gathering unit 601, adapted to gather or obtain the characteristic information of the input target object of the input information after it is determined by the legitimacy determining unit 404 that the input target object of the input information is not a legitimate object; and

a sending unit 602, adapted to send the input target object of the input information to a cloud server as an illegitimate object after it is determined in accordance with the character information gathered by the information gathering unit 601 that the input target object of the input information is a malicious program.

A system for trojan horse interception is further provided according to an embodiment of the present disclosure, as shown in FIG. 7, which includes, a terminal 701 and a cloud server 702, wherein the terminal 701 is adapted to intercept input information from a user and determine whether the input information is identical to saved information to be protected; and send a warning prompt, if the input information is identical to the saved information to be protected and a query by the terminal 701 to the cloud server 702 shows that an input target object of the input information is not a legitimate object.

According to the above scheme, all the input information can be intercepted, and a warning is sent if the input information is identical to the saved information to be protected and an input target object of the input information is not illegitimate. The above scheme is not limited to monitor a certain input target object, and as such, range of applications that are protected is more extensive. It may be unnecessary for the user to take precautions in entering the correct (e.g., non-malicious) web address or operating the correct program, so the requirement for the user is lowered, and thereby the above scheme provides enhanced security.

Further, in order to further improve security, it is possible that a non-reversible representation of confidential information to be protected and derived from the confidential information is saved at the terminal side, instead of the confidential information itself. In particular, the terminal 701 is further adapted to receive the information to be protected, convert the information to be protected into non-reversible representation of the information to be protected, and save the non-reversible representation of information to be protected before it is determined whether the input information is the same as the saved information to be protected.

Determining by the terminal 701 of whether the input information is identical to the saved information to be protected may include: converting the input information into non-reversible representation of the input information corresponding to the input information, and determining whether the non-reversible representation of the input information which corresponds to the input information is identical to the saved non-reversible representation of the information to be protected.

In some variations, in an example of non-reversible information is provided according to an embodiment of the present disclosure, the terminal 701 is adapted to convert the information to be protected into a hash algorithm value, and convert the intercepted input information into a hash algorithm value corresponding to the input information.

Alternatively, a scheme through which the illegitimate object in cloud can be counted and the ability of recognizing trojan horse can be enhanced is further provided according to an embodiment of the present disclosure, the terminal 701 is further adapted to gather the character information of the input target object of the input information after it is determined that the input target object of the input information is not a legitimate object, and send the input target object of the input information to a cloud server 702 as an illegitimate object after it is determined in accordance with the character information that the input target object of the input information is a malicious program.

It should be noted that in the embodiment of terminal described above, the various units therein are only divided by functional logic, but are not limited by the division described above, as long as the related function can be implemented. In addition, the naming of a function unit is only used to distinguish it easily, and is not used to limit the scope of protection of the present disclosure.

In addition, it can be understood by those skilled in the art that the all or some of the procedures can be achieved by instructing the related hardware through a program. The corresponding program can be stored in a computer readable storage medium, which can be a ROM, a magnetic disk or an optical disk.

The above descriptions are only the better specific embodiments of the present disclosure, and the scope of protection of the present disclosure is not limited thereto. Any variation or replacement which can be easily thought by those skilled in the art in the technical scope disclosed in the present disclosure should be covered within the scope of protection of the present disclosure. Therefore, the scope of protection of the present invention should be in accordance with the scope of the claims.

The methods, devices, systems, programs, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for trojan horse interception, comprising:
in a terminal connected to a network:
intercepting input information, and determining whether the input information is identical to saved information to be protected; and
sending a warning prompt, when:
the input information is identical to the saved information to be protected; and
an input target object of the input information is not a legitimate object.

2. The method according to claim 1, further comprising:
before the determining whether the input information is identical to the saved information to be protected, receiving the saved information to be protected, converting the saved information to be protected into a non-reversible representation of the saved information, and saving the non-reversible representation of the saved information; and
determining whether the input information is identical to the saved information to be protected by:
converting the input information into a non-reversible representation of the input information; and
determining whether the non-reversible representation of the input information is identical to the saved non-reversible representation of the saved information.

3. The method according to claim 2, wherein the non-reversible representation of the saved information comprises a hash algorithm value.

4. The method according to claim 1, further comprising determining whether the input target object of the input information is a legitimate object by:
comparing characteristic information of the input target object of the input information with legitimate characteristic information of the input target object saved in a cloud server; and
determining that the input target object of the input information is not a legitimate object when the characteristic information of the input target object of the input information has illegitimate information or unknown information.

5. The method according to claim 4, further comprising, after the determining that the input target object of the input information is not a legitimate object:
obtaining the characteristic information of the input target object of the input information, and
sending the input target object of the input information to the cloud server as an illegitimate object if it is determined in accordance with the characteristic information that the input target object of the input information comprises a malicious program.

6. A device for trojan horse interception, comprising:
an input unit, adapted to receive input information;
an intercepting unit, adapted to intercept the input information inputted by a user through the input unit;
a comparison unit, adapted to determine whether the input information intercepted by the intercepting unit is identical to the saved information to be protected;
a legitimacy determination unit, adapted to determine whether an input target object of the input information is a legitimate object when the comparing unit determines that the input information is identical to the saved information to be protected; and
a warning unit, adapted to send a warning prompt when the legitimacy determination unit determines that the input target object of the input information is not a legitimate object.

7. The device according to claim 6, further comprising:
a protected information receiving unit, adapted to receive the saved information to be protected prior to determining whether the input information is identical to the saved information to be protected; and
a conversion unit, adapted to:
convert the saved information to be protected into a non-reversible representation of the saved information; and
convert the input information intercepted by the intercepting unit into a non-reversible representation of the input information; and
wherein the comparison unit is adapted to determine whether the input information intercepted by the intercepting unit is identical to saved information to be protected by determining whether the non-reversible representation of the input information is identical to the non-reversible representation of the saved information.

8. The device according to claim 7, wherein the conversion unit is adapted to:
convert the saved information to be protected into the non-reversible representation of the saved information as a hash algorithm value corresponding to the saved information; and
convert the input information into the non-reversible representation of the input information as a hash algorithm value corresponding to the input information.

9. The device according to claim 6, wherein the comparison unit is further adapted to:
compare characteristic information of the input target object of the input information with legitimate characteristic information of the input target object saved in a cloud server, and
determine that the input target object of the input information is not a legitimate object when the characteristic information of the input target object of the input information has illegitimate information or unknown information.

10. The device according to claim 9, further comprising:
an information gathering unit, adapted to gather the characteristic information of the input target object of the input information after the legitimacy determination unit determines that the input target object of the input information is not a legitimate object; and
a sending unit, adapted to send the input target object of the input information to the cloud server as an illegitimate object after it is determined in accordance with the characteristic information gathered by the information gathering unit that the input target object of the input information comprises a malicious program.

11. A system for trojan horse interception, comprising:
a terminal in communication with a cloud server, wherein the terminal is adapted to:
intercept input information from a user and determine whether the input information is identical to saved information to be protected; and
send a warning prompt, when the input information is identical to the saved information to be protected and a response from the cloud server to a query sent by the terminal indicates that an input target object of the input information is not a legitimate object.

12. The system according to claim 11, wherein the terminal is further adapted to:
receive the saved information to be protected;
convert the saved information to be protected into non-reversible representation of the saved information; and
save the non-reversible representation of the saved information before determining whether the input information is identical to the saved information to be protected; and
wherein the terminal is adapted to determine whether the input information is identical to the saved information to be protected by:
converting the input information into the non-reversible representation of the input information; and
determining whether the non-reversible representation of the input information is identical to the saved non-reversible representation of the saved information.

13. The system according to claim 12, wherein the terminal is adapted to:
convert the saved information to be protected into the non-reversible representation of the saved information by converting the saved information into a hash algorithm value, and convert the input information into the non-reversible representation of the input information by converting the input information into a hash algorithm value corresponding to the input information.

14. The system according to claim 11, wherein the terminal is further adapted to:
obtain characteristic information of the input target object of the input information after it is determined that the input target object of the input information is not a legitimate object; and
send the input target object of the input information to a cloud server as an illegitimate object after it is determined, in accordance with the characteristic information, that the input target object of the input information comprises a malicious program.

15. The method according to claim 2, wherein determining whether the input target object of the input information is a legitimate object comprises:
comparing characteristic information of the input target object of the input information with legitimate characteristic information of the input target object saved in a cloud server; and
determining that the input target object of the input information is not a legitimate object if the characteristic information of the input target object of the input information has illegitimate information or unknown information.

16. The method according to claim 3, wherein determining whether the input target object of the input information is a legitimate object comprises:
comparing characteristic information of the input target object of the input information with legitimate characteristic information of the input target object saved in a cloud server; and
determining that the input target object of the input information is not a legitimate object if the characteristic information of the input target object of the input information has illegitimate information or unknown information.

17. The device according to claim 7, wherein the comparison unit is further adapted to:
compare characteristic information of the input target object of the input information with legitimate characteristic information of the input target object saved in a cloud server; and
determine that the input target object of input information is not a legitimate object if the characteristic information of the input target object of the input information has illegitimate information or unknown information.

18. The device according to claim 8, wherein the comparing unit is further adapted to:
compare characteristic information of the input target object of the input information with legitimate characteristic information of the input target object saved in a cloud server; and
determine that the input target object of the input information is not a legitimate object if the characteristic information of the input target object of the input information has illegitimate information or unknown information.

19. The system according to claim 12, wherein the terminal is further adapted to:
obtain characteristic information of the input target object of the input information after it is determined that the input target object of the input information is not a legitimate object; and
send the input target object of the input information to a cloud server as an illegitimate object after it is determined, in accordance with the characteristic information, that the input target object of the input information comprises a malicious program.

20. The system according to claim 13, wherein the terminal is further adapted to:
obtain characteristic information of the input target object of the input information after it is determined that the input target object of the input information is not a legitimate object; and
send the input target object of the input information to a cloud server as an illegitimate object after it is determined, in accordance with the characteristic information, that the input target object of the input information comprises a malicious program.
